(19) United States
(12) Patent Application Publication
(10) Pub. No.: US 2025/0375902 A1
(43) Pub. Date: Dec. 11, 2025

(54) GRIPPER, TRANSPORT DEVICE AND METHOD FOR PICKING UP AND GRIPPING INDIVIDUAL SHEET-SHAPED ELECTRODES

(71) Applicant: GROB-WERKE GmbH & Co. KG, MINDELHEIM (DE)

(72) Inventors: Tim JANUSCH, ERKHEIM (DE); Matthias HROMADA, OBERGÜNZBURG (DE); Tobias KAUFMANN, AUFKIRCH (DE); Tobias SCHATZ, BAD GRÖNENBACH (DE)

(21) Appl. No.: 19/231,664

(22) Filed: Jun. 9, 2025

(30) Foreign Application Priority Data
Jun. 10, 2024 (EP) 24181194.2

(51) Int. Cl. B25J 15/06; B25J 11/00; B25J 13/08

(52) U.S. Cl. CPC B25J 15/0616; B25J 11/005; B25J 13/08

(57) ABSTRACT

A gripper for picking up and gripping individual sheet-like electrodes while manufacturing a battery cell. The gripper has a suction device for aspirating the electrode. The gripper has a first gripper segment and a second gripper segment, wherein the suction device has a first suction device arranged on the first gripper segment for aspirating a first region of the electrode to be gripped and a second suction device arranged on the second gripper segment for aspirating a second region of the electrode to be gripped. The gripper also includes a displacement unit for relatively displacing the first and second gripper segments with at least one directional component parallel to the surface of the electrode to be gripped.

### CROSS-REFERENCES TO RELATED APPLICATIONS

This application claims the benefit of European Patent Application Number 24 181 194.2 filed on Jun. 10, 2024, the entire disclosure of which is incorporated herein by way of reference.

### BACKGROUND OF THE INVENTION

The invention relates to a gripper for picking up and gripping individual sheet-like electrodes in the course of the manufacture of a battery cell, comprising a suction device for aspirating the electrode to be gripped. The invention further relates to a transport device for picking up and transporting individual sheet-like electrodes in the course of the manufacture of a battery cell, which transport device has at least one such gripper. The invention further relates to a method for picking up and gripping individual sheet-like electrodes in the course of the manufacture of a battery cell, as well as a computer program with instructions for carrying out such a method.

For the technological background, reference is made to the following literature:
[1] WO 2023/072343 A1
[2] EP 4 258 398 A1
[3] EP 4 258 402 A1
[4] JP 2017 152 075 A
[5] JP 2007 119 216 A
[6] EP 4 212 464 A1
[7] EP 2 064 594 A2
[8] CN 116924109 A

Embodiments of the invention are used in the field of battery cell production and battery stack assembly. In particular, the invention relates to devices and methods for gripping sheet-like electrodes. A particularly preferred application is the separation/singulation of electrodes pre-stored in magazines within a Z-folding process, as described and shown, for example, in documents [1] to [3].

Document [1] deals with a “method and device for manufacturing Z-folded cell stacks” and more specifically relates to a method and device for manufacturing Z-folded cell stacks, wherein a separator web is folded in a Z-shape around alternately stacked first and second cell components. In order to significantly reduce the process time, it is provided that the folding takes place during the feeding of the respective cell component by means of a folding element arranged to move with a respective gripper.

Documents [2] and [3] deal with a “device and method for manufacturing wrapped Z-folded cell stacks,” wherein a device and method for wrapping cell stacks formed in particular by Z-folding cell components, more particularly for a battery cell or the like, are to be improved.

The principle of Z-folding is frequently used in battery stack assembly. In order to decouple the separation process of the electrodes and the actual stacking process of the battery stack, the electrodes are stored in magazines and fed to the individual stack cells. The greatest challenge in the (re) separation of the magazine-stored electrodes is to avoid double or multiple removal.

Documents [4] to [8] are partly from the field of battery cell production and partly from completely different areas of technology and relate to measures designed to prevent multiple removal of components from magazines or similar devices. However, the mechanisms used are limited to the use of bellows suction devices and flat suction devices. The components to be separated are often fanned out by blowing separating air into the stored components.

In order to specifically prevent multiple removal in the field of battery cell production, the following technical approaches are currently being pursued:
blowing separating air into the stored electrode stack
use of full-surface suction grippers in combination with a “shaking” movement profile of the axis. Multiple removal is detected by so-called double-layer sensors
mechanical retention by means of stripping plates

The injection of separating air leads to a large-scale distribution or emission of particles in the system. Cross-contamination between the anode and cathode is particularly critical in battery cell production. A shaking motion of a gripper axis (in the sense of a movement mechanism/actuator for a gripper) takes a lot of cycle time, which conflicts with the growing cycle time requirements of potential customers. It is therefore not possible to meet these requirements with this approach.

Retaining the electrodes with a mechanical scraper plate/mechanical retention device leads to damage to the electrode and massive release of particles in the case of double or multiple removal.

### SUMMARY OF THE INVENTION

The invention is based on the problem of improving a gripper, a transport device, and a method for picking up and holding or transporting sheet-like electrodes in the course of manufacturing battery cells in such a way that multiple pickups can be better avoided while improving the quality of the battery cell to be manufactured.

To solve this problem, the invention provides a gripper to one of the embodiments described below. A transport device equipped with such a gripper, a method for picking up electrodes, and a computer program with instructions for carrying out the method are also disclosed.

According to a first alternative, the invention provides a gripper for picking up and gripping individual sheet-like electrodes in the course of the manufacture of a battery cell, with a suction device for aspirating the electrode to be gripped, wherein the gripper has a first gripper segment and a second gripper segment, wherein the suction device comprises a first suction device arranged on the first gripper segment for aspirating a first region of the electrode to be gripped and a second suction device arranged on the second gripper segment for sucking a second region of the electrode to be gripped, wherein the gripper further comprises a displacement unit for displacing the first and second gripper segments relative to each other with at least one directional component parallel to the surface of the electrode to be gripped.

The displacement unit enables the gripper segments to be displaced in the direction of the extension of the electrode to be gripped. The displacement unit enables the electrode to be gripped to be bulged in a targeted manner by simple and safe means. The bulging can be effected over the longer side or over the shorter side, in particular if the electrodes are almost square.

In some embodiments, the displacement unit is therefore designed to move the first and second gripper segments relative to each other parallel to a longitudinal direction of the electrode to be gripped in order to bulge the longer side. In some embodiments, the displacement unit is designed to move the first and second gripper segments relative to each other parallel to the initial surface of the electrode to be gripped and transversely to the longitudinal extension direction in order to bulge the shorter side.

In some embodiments, it is provided that the displacement unit comprises a guide device for linearly guiding the first and second gripper segments relative to each other.

In some embodiments, it is provided that the displacement unit comprises an actuator for driving the displacement movement.

In some embodiments, it is provided that the displacement unit comprises an internal guide device formed on the gripper segments, which internal guide device has a projection on one of the gripper segments and a recess on the other of the gripper segments, wherein the projection can be received in a form-fitting manner in the recess.

In some embodiments, it is provided that the displacement unit comprises an external guide device having at least one rail on which the gripper segments are guided in a displaceable manner.

In some embodiments, it is provided that the displacement unit comprises a guide system on which the first gripper segment is guided in a displaceable manner and on which the second gripper segment is guided in a displaceable manner.

In some embodiments, it is provided that the displacement unit is designed such that the relative displacement of the first and second gripper segments only takes place in one plane.

In some embodiments of the first alternative, it is provided that the suction device comprises said plurality of bellows suction devices for punctual aspiration of the electrode and the at least one suction field for flatly aspirating the electrode.

According to a second alternative, the invention provides a gripper for picking up and gripping individual sheet-like electrodes in the course of the manufacture of a battery cell, with a suction device for aspirating the electrode to be gripped, wherein the suction device has several bellows suction devices for punctually aspirating the electrode and at least one suction field for aspirating the electrode over a large area.

In some embodiments, the features of the first and second alternatives are provided cumulatively.

In some embodiments, it is provided that the bellows suction devices are designed and arranged to produce a targeted bulging of the electrode by punctual aspiration.

In some embodiments, it is provided that the bellows suction devices are designed and arranged to be controlled individually.

In some embodiments, it is provided that the bellows suction devices are designed to be formed at least in part on the first suction device.

In some embodiments, it is provided that the bellows suction devices are designed to be formed at least in part on the second suction device.

In some embodiments, it is provided that the bellows suction devices are distributed over the first gripper segment and the second gripper segment.

In some embodiments, it is provided that the first suction device has a first suction field.

In some embodiments, it is provided that the second suction has a second suction field.

In some embodiments, it is provided that the at least one suction field is designed and arranged to generate full-surface gripping of the electrode after successful separation of the electrode to be gripped.

The gripper geometry is based on the electrode to be gripped, in particular the electrode format, the arrangement of the arrester tabs, etc.

Depending on the format, some embodiments may provide that the first and second suction devices are designed essentially identically or as mirror images of each other.

Some embodiments of the gripper according to the first and/or second alternative have a nozzle unit integrated into the gripper, which nozzle unit is designed to deliver an air flow or an air pulse at a predetermined oblique angle at at least one edge of the electrode to be gripped.

According to a third alternative, the invention provides a gripper for picking up and gripping individual sheet-like electrodes in the course of the manufacture of a battery cell, with a suction device for aspirating the electrode to be gripped and with a nozzle unit integrated into the gripper, which nozzle unit is designed to deliver an air flow or an air pulse at a predetermined oblique angle at at least one edge of the electrode to be gripped.

In some embodiments, a gripper is provided which combines the features of the first and third alternatives. In some embodiments, a gripper is provided which combines the features of the second and third alternatives. In some embodiments, a gripper is provided which combines the features of the first to third alternatives.

In some embodiments, it is provided that the nozzle unit is a ring nozzle or has a ring nozzle that is designed to deliver the air flow or air pulse at each of the edges on the circumference of the electrode to be gripped.

In some embodiments, it is provided that the nozzle unit has slots offset laterally to the suction device.

In some embodiments, it is provided that the nozzle unit has a first nozzle region on the first gripper segment and a second nozzle region on the second gripper segment.

Some embodiments of the gripper according to the first, second, and/or third alternatives have a sensor for detecting whether one or more electrodes have been picked up by the gripper.

According to a further aspect, the invention provides a transport device for picking up and transporting individual sheet-like electrodes in the course of the manufacture of a battery cell, comprising at least one gripper according to one of the above configurations, a movement mechanism for moving the gripper, and a computer-implemented control.

According to a further aspect, the invention provides a method for picking up and gripping individual sheet-like electrodes in the course of the manufacture of a battery cell according to the alternatives described in the following.

Currently, the first alternative of the method is preferred, which is why it is also the subject of the current set of claims. However, the present disclosure also includes the further alternatives described below, either alone or in any combination with one another.

According to the first alternative for the method, the invention provides a method for picking up and gripping individual sheet-like electrodes in the course of the manufacture of a battery cell, comprising:
aspirating a first region of the electrode with a first suction device and aspirating a second region of the electrode with a second suction device and relative displacement of the first and second suction devices with at least one directional component parallel to the sheet-like extension of the electrode in order to specifically bulge the electrode for separation.

In particular, the relative displacement of the first and second suction devices takes place in the direction of the (initial) extension of the electrode to be gripped. The relative displacement allows the electrode to be bulged in a targeted manner by simple and safe means. The bulging can take place over the longer and shorter sides, in particular if the electrodes are almost square.

In some embodiments, the relative displacement of the first and second suction devices is parallel to a longitudinal direction of the electrode to be gripped in order to bulge the longer side. In some embodiments, the relative displacement of the first and second suction devices is parallel to the initial surface of the electrode to be gripped and transverse to the longitudinal direction in order to bulge the shorter side.

Preferably, the method comprises the step of:
punctually aspirating the electrode in such a way that a bulging of the electrode is already produced during aspirating.

According to the second alternative for the method, the invention provides a method for picking up and gripping individual sheet-like electrodes in the course of the manufacture of a battery cell, comprising:
punctually aspirating the electrode in such a way that the electrode is bulged already during aspirating.

This can take place alternatively or in addition to the relative displacement.

Preferably, the method according to the first and/or second alternative comprises the additional step of:
blowing at an angle onto at least one, several or all of the edges of the electrode in order to detach a further electrode adhering thereto.

According to the third alternative for the method, the invention provides a method for picking up and gripping individual sheet-like electrodes in the course of the manufacture of a battery cell, comprising:
aspirating the electrode and
blowing at an angle onto at least one, several or all of the edges of the electrode in order to detach a further electrode adhering thereto.

Preferred embodiments of the method according to one or more of the preceding alternatives comprise the further step of:
detecting whether the gripped electrode has been successfully separated and, depending on this, flatly aspirating the electrode if it has been successfully separated and/or transporting the electrode only when it has been successfully separated.

Preferably, the method according to one or more of the above alternatives and embodiments is carried out with a gripper or the transport device according to one or more of the alternatives or embodiments described above.

According to a further aspect, the invention provides a computer program comprising instructions that cause a gripper or a transport device of one or more of the above alternatives or embodiments to carry out the method according to one or more of the above alternatives or embodiments.

Preferred embodiments of the invention are used in the field of battery cell manufacturing, in particular by Z-folding. Embodiments of the invention are particularly preferred in devices and methods as described in documents [1] to [3], for feeding cathodes or anodes. The cathode grippers may be designed differently from the anode grippers in this case.

Special embodiments relate to a displacement gripper in which different segments can be displaced relative to one another in order to deliberately cause the electrode gripped by them to bulge.

Alternatively or additionally, further measures are provided to prevent multiple removal of electrodes from the respective magazines.

Preferred embodiments of the invention have at least one, several or all of the following advantages:
by avoiding a “shaking” movement profile, no additional time is required for separating the electrodes
mechanical damage to the electrodes can be prevented by eliminating mechanical retention
low process stability due to double or multiple removals and special sequences in the event of double or multiple removals is prevented

Preferred embodiments of the invention enable a more process-reliable, component-friendly and, at the same time, dynamic separation process for electrodes pre-stored in a magazine.

Preferred embodiments of the invention meet one, several or all of the following requirements:
ensuring reliable and highly dynamic separation of the electrodes
adapting one or more of the operating principles described in the following point for separating the electrodes to the requirements and needs of the separation process of the respective electrode type, i.e., anode and cathode
one or more of the following operating principles must be implemented in terms of design so as to comply with the available space of a separation gripper:
   a bellows suction device (punctual aspiration)
   a suction field (flat aspiration)
   a ring nozzle
   a displacement unit (displacement of gripper segments, in particular of gripper halves relative to each other)
   double-layer sensor
the ability to handle a wide variety of different anode and cathode materials (primarily thickness and coating) while maintaining consistent separation quality.

In preferred embodiments of the invention, the individual anode and cathode sheets pre-stored in a magazine are separated in a process-reliable manner using individual or a combination of different operating mechanisms.

In the case of double or multiple removal, the core of the problem is simply the adhesion of the electrodes to each other.

In this case, the surrounding air cannot flow in between the individual sheets at a sufficient speed to ensure that the electrodes are detached.

The system(s) implemented in the gripper ensures/ensure that air can flow in between the individual sheets.

In this case, electrostatic adhesion is considered separately and removed by the use of ionization devices, which are additionally provided in some embodiments.

Some advantages of some embodiments are:
by avoiding a “shaking” motion profile, no additional time is required for separating the electrodes
mechanical damage to the electrodes can be prevented by eliminating mechanical retention
the emission of particles can thus be greatly reduced.
due to the plurality of operating mechanisms provided by the design, different combinations can be used to respond to the respective requirements of the electrodes (anode/cathode) or their structure (thickness, coating, etc.) without having to change the system
achievement of a process-reliable, component-friendly, and at the same time dynamic separation process for electrodes pre-stored in a magazine

In particular, systems (grippers, methods, transport devices, systems for manufacturing by means of Z-folding, . . . ) according to particularly preferred embodiments of the invention pursue operating principles that can be used individually or in combination to avoid double or multiple removals.

Summary of the systems and their operating principles (physical) in their preferred embodiments:
Bellows suction device (punctual aspiration)
   punctual aspiration of the uppermost electrode causes the electrode to bulge in a targeted manner
   the resulting peeling effect on the electrodes below improves the air inflow between them
Suction field (flat aspiration)
   once successful separation has been achieved, the suction field can be used to generate full-area gripping of the electrode
   the electrode can thus be transported to the stacking table in a more component-friendly manner (avoiding flow-induced fluttering of the electrode during transport from the removal position to the stacking position).
Ring nozzle (example of a device for blowing in at an angle at the surrounding sides of the electrode)
   an integrated ring nozzle allows an air flow or air pulse to be directed at an angle onto the edge or edges of the removed electrodes
   in the case of double or multiple removal, this effect causes air to be blown in between the electrodes, which accelerates the release of the electrodes and, on the other hand, the outflow of air creates a vortex below the electrodes, which generates a local area of low pressure that sucks the additional electrodes that have been removed back toward the magazine
Shifting unit
   similar to the bellows suction device, the displacement unit aims to create a targeted bulging of the electrodes (forming a peeling effect→replenishing air flows in)
   the amplitude of the bulging can be adjusted by the travel distance of the displacement unit (parallel gripper) and fine-tuned to the respective electrode configuration
   in combination with the bellows suction device, the contour of the bulging can be determined (number of amplitudes, high points, low points, curvature radii, etc.)
Double layer sensor
   the double layer sensor serves as a control system
   only when the sensor gives the go-ahead (no double layer present) is the axis allowed to move toward the stacking position
   this ensures that any additional electrodes that are removed can fall back into the magazine

### BRIEF DESCRIPTION OF THE DRAWINGS

Embodiments are described in more detail below with reference to the attached drawings in which it is shown by:

FIG. 1 a perspective view of an embodiment of a gripper for picking up and holding sheet-like electrodes in the course of the manufacture of batteries, wherein possible units and, in particular, components of an optional displacement unit are explained in different combinations;

FIG. 2 is another perspective view of the gripper, showing further components for displacement and schematically representing a transport device and a control system;

FIG. 3 is the view as in FIG. 1, illustrating different units for aspirating the electrode to be gripped;

FIG. 4 the view as in FIG. 1 to illustrate an embodiment of a nozzle unit integrated into the gripper;

FIG. 5 a highly schematized sectional view through part of the nozzle unit with an indication of the gripper and double-adhesive electrodes to illustrate a mode of action of the nozzle unit; and

FIG. 6 is a view as in FIG. 5 to illustrate a further mode of action of the nozzle unit.

### DETAILED DESCRIPTION OF THE PREFERRED EMBODIMENTS

The Figures show preferred embodiments of a gripper 10 and a transport device 12 equipped with it. The gripper 10 is designed to pick up and grip individual sheet-like electrodes in the course of the manufacture of a battery cell and is equipped with a suction device 14 for aspirating the electrode to be gripped.

The gripper 10 and the transport device 12 are designed for use in the large-scale production of battery units, in particular by Z-folding, as described and shown, for example, in documents [1] to [3]. Such production runs are carried out at very high speeds. The gripper 10 is designed to pick up one of the electrode types-cathode or anode-in the respective configuration from a magazine (not shown) and feed it to the Z-folding device.

In the preferred embodiment of the gripper 10 as shown, a displacement unit 16, different suction units 18, 20 of the suction device 14 for punctual and flat aspiration at different stages of the gripping process, a nozzle unit 22 for removing a further electrode, and a double-layer sensor 24 are integrated. The aforementioned units 16, 18, 20, 22, 24, either individually or in combination, prevent more than one sheet-like electrode from being picked up in a process-reliable and component-friendly manner. Depending on the design of the electrode and the gripping process, some of the aforementioned operating principles are omitted or combined in a different manner in other grippers not shown here in detail.

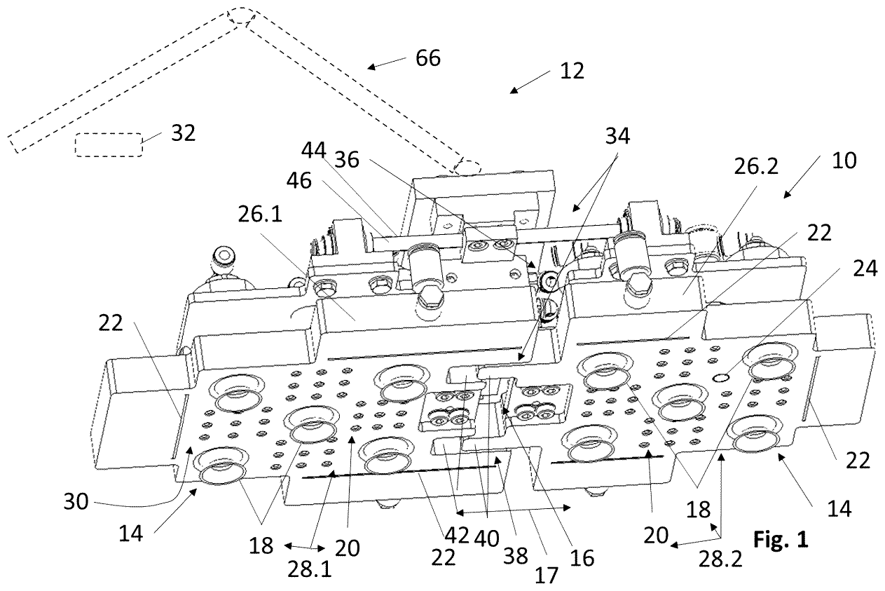

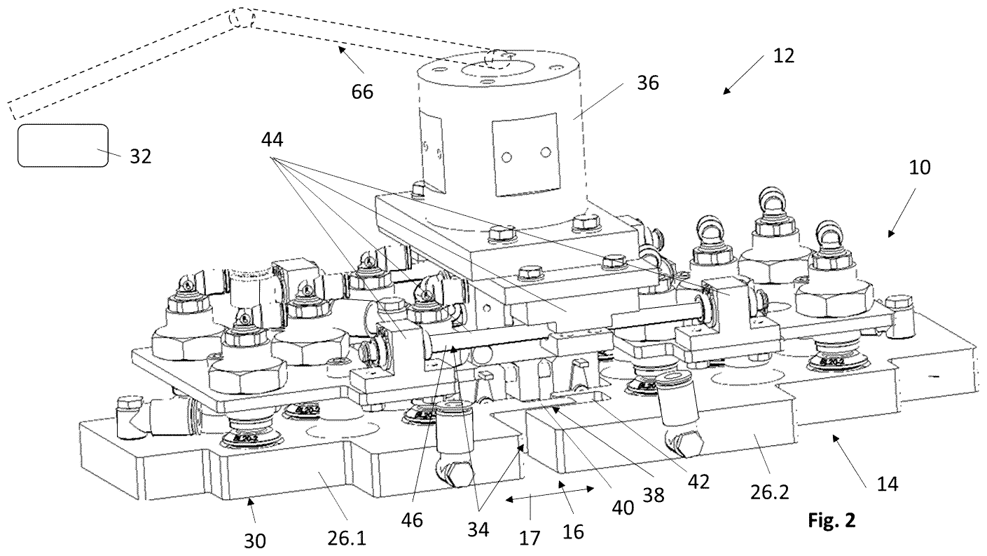

Preferred embodiments of the displacement unit 16 are explained in more detail below with reference to the illustrations in FIGS. 1 and 2.

The gripper 10 has a first gripper segment 26.1 and a second gripper segment 26.2. The gripper segments 26.1, 26.2 can, for example, be designed as gripper halves. In other embodiments not shown, the first and second gripper segments 26.1, 26.2 are not distributed approximately equally on the gripper, but are of different sizes. The design of the gripper segments 26.1, 26.2 depends on the electrode to be gripped in each case and is optimized for this.

The suction device 14 has a first suction device 28.1 arranged on the first gripper segment 26. 1 for aspirating a first region of the electrode to be gripped and a second suction device 28.2 arranged on the second gripper segment 26.2 for aspirating a second region of the electrode to be gripped. Possible designs of the respective suction devices 28.1, 28.2 are explained in more detail below in the description of the different suction units 18, 20.

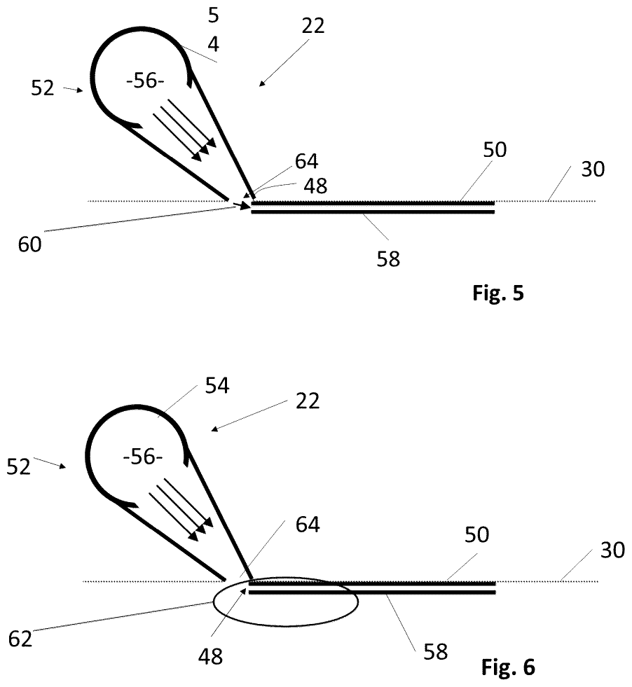

The gripper 10 further comprises the displacement unit 16 for relatively displacing the first and second gripper segments 26.1, 26.2. The displacement unit 16 is designed to displace the gripper segments 26.1, 26.2 with at least one directional component parallel to the extension plane of the electrode to be gripped. The displacement movement is shown in FIG. 1 with arrow 17. In the embodiments shown, the gripper 10 has a gripping side—for example, the underside of the gripper 10 during operation-on which the suction device 14 is formed and on which the electrode is to be held. In FIGS. 5 and 6, this underside is illustrated as a gripper plane 30. In this design, the displacement unit 16 is specifically designed to move the gripper segments 26.1, 26.2 relative to each other parallel to the gripping side-gripper plane 30. For example, the relative movement can be directed toward the long side of the electrode to be gripped or toward the shorter side of the electrode to be gripped. In particular, the displacement movement 17 is a linear movement.

By moving the gripper segments 26.1, 26.2 relative to each other while the first and second regions of the electrode are adhered, the electrode can be bulged in a targeted manner.

The relative movement can be initiated by suitable actuators 36 and a control system 32 indicated in FIG. 2—computer-implemented, with a processor and memory in which a computer program is loaded. In this way, the bulging can be specifically adjusted to the respective electrode purely by adjusting the control parameters.

The displacement unit 16 enables the two gripper halves-example of gripper segments 26.1, 26.2—to be moved relative to each other, thereby producing a bulging of the aspirated electrode or electrodes in the case of double or multiple removal of the aspirated electrodes.

According to FIGS. 1 and 2, the displacement unit 16 has a guide device 34 for linearly guiding the first and second gripper segments 26.1, 26.2 relative to each other. The displacement unit 16 further has an actuator for driving the displacement movement. The guide device 34 has an internal guide device 38 formed on the gripper segments 26.1, 26.2, which, in the embodiment shown, has a projection 40 on one of the gripper segments 26.1, 26.2 and a recess 42 on the other of the gripper segments 26.1, 26.2, so that the projection 40 can be received in a form-fitting manner in the recess 42.

In addition to the “internal” guide device 38 of the displacement unit 16 (parallel gripper), an external circular guide system 44 is provided to increase the overall rigidity of the system. For example, the guide device 34 has an external guide device with at least one rail 46 on which the gripper segments 26.1, 26.2 are guided so that they can be displaced.

From the point of construction, the components of this circular guide system 44 are standard components. The task of this external guide system 44 is to relieve the internal guide 38 of the parallel gripper and to stiffen the overall system. As a result, the displacement of the gripper halves relative to each other should only take place in the plane.

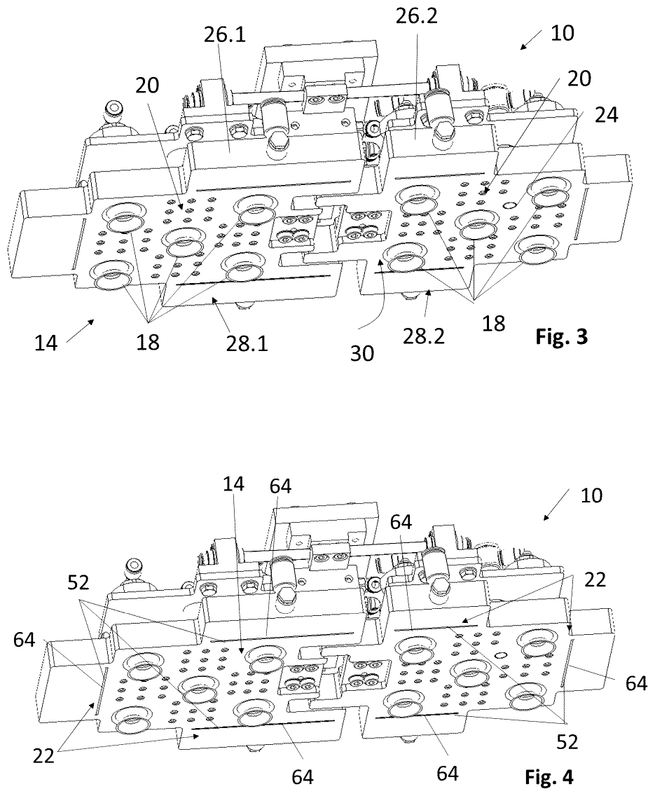

According to FIG. 3, the suction device 14 has several bellows suction devices 18 for punctual aspiration of the electrode and at least one suction field 20 for flat aspiration of the electrode.

The bellows suction devices 18 are designed and arranged to be controlled individually and to produce targeted bulging of the electrode by punctual aspiration. In the embodiment shown, some of the bellows suction devices 18 are arranged on the first suction device 28.1, and further bellows suction devices 18 are arranged on the second suction device 28.2; for example, the bellows suction devices 18 are distributed over the gripper segments 26.1, 26.2.

The bellows suction device 18 enables different variants of bulging. The embodiment shown has five bellows suction devices 18 per gripper half. The bellows suction devices 18 can be individually controlled via the control system 32, which allows a wide variety of “peeling effects” to be generated to detach the electrodes. In addition, the bellows suction devices 18 can be contracted to transfer the separated electrode to the suction field 20. This drastically reduces the effect of air resistance and the resulting “fluttering effects” for the subsequent transport of the separated electrode to the stacking position.

As a unit for flat aspiration, the suction device 14 has at least one suction field 20. In the embodiment shown, both the first suction device 28.1 and the second suction device 28.2 each have a suction field 20. The design of the suction field or fields 20 also depends on the electrode to be gripped. In the embodiment shown, the suction fields 20 of the first and second suction devices 28.1, 28.2 are essentially identical or mirror images of each other.

The at least one suction field 20 is provided with a vacuum source (not shown, e.g., pump with valves) and controlled by the control system 32 and thereby designed and arranged to generate gripping of the electrode over the entire surface after successful separation of the electrode to be gripped.

For example, the suction field 20 is formed by a perforated surface (e.g., perforated plate, field of bores) on the underside of a gripper body (more precisely, one gripper body of each gripper segment 26.1, 26.2), wherein the openings/bores of the suction field 20 open into a vacuum chamber in which a vacuum is generated or not, controlled by the control system 32.

The suction field 20 represents the most commonly used state of the art (full-surface gripping of the electrode by vacuum means using an area gripper) and is therefore generally known and will not be described in more detail at this point.

In the gripper system described here, the suction field 20 can serve as a transport aid for an electrode that has already been separated by other operating principles (see above description of the bellows suction device).

On the other hand, the at least one suction field 20 or the multiple suction fields 20 can create a further combination option for improving the separation process and for avoiding double or multiple removals. In the embodiment shown, the suction fields 20 of the two gripper halves can be controlled and operated independently of each other.

In the following, an embodiment of the nozzle unit 22 is described in more detail with reference to the FIGS. 4 to 6. The nozzle unit 22 is integrated into the gripper 10 and is designed to deliver an air flow or an air pulse at a predetermined oblique angle onto at least one edge 48 of the electrode 50 to be gripped.

In FIGS. 5 and 6, the gripper 10 is indicated by a schematic representation of the gripper plane 30—i.e., the flat area where the electrode 50 adheres or, in other words, where the suction device 14 is located. In the gripper body on which the gripper plane 30 is formed, the nozzle unit 22 is designed, for example, as a ring nozzle 52. In particular, the nozzle unit 22 is designed as a circumferential ring nozzle 52 along the outer geometry of the electrode 50. Blowing air 56 is fed into an air duct 54 running around the circumference, for example, and directed toward the edge 48 of the adhering electrode 58 so that the air flows against it at an angle. In FIGS. 5 and 6, a double removal is assumed, with a further electrode 58 adhering to the electrode 50 to be gripped.

FIGS. 5 and 6 show a detailed view of the nozzle unit 22 to explain the effects that occur. A first effect is shown in FIG. 5. The nozzle unit 22 generates an air flow 60 between the electrode sheets 50, 58. A second effect is shown in FIG. 6. In the circled area, a negative pressure area 62 or a downward suction of the further electrode 58 is formed. This is based on the Bernoulli effect or a boundary layer separation.

In the embodiments shown, the nozzle unit 22 is therefore a ring nozzle 52 or includes a ring nozzle. The ring nozzle 52 is designed to deliver the air flow 60 or the air impulse to each of the edges 48 on the circumference of the electrode 50 to be gripped.

In the embodiments shown, the nozzle unit 22 has slots 64 offset laterally to the suction device 14. If the gripper 10 has the displacement unit 16 and is divided into several segments 26.1, 26.2, the nozzle unit 22 has, in particular, a first nozzle area on the first gripper segment 26.1 and a second nozzle area on the second gripper segment 26.2.

The ring nozzle 52 ensures accelerated inflow of air between the electrode sheets 50, 58 during double or multiple removal by means of an air flow 60 or air pulse entering at a certain angle, resulting in separation of the electrodes, see FIG. 5.

In addition, due to the Bernoulli effect or the boundary layer separation of the escaping air, an area 62 of local negative pressure is created, whereby the incorrectly removed electrodes 58 are sucked toward the magazine, see FIG. 6.

Various measures have been described above to prevent double or multiple removal in a process-reliable and gentle manner, even in fast processes. The displacement unit 16 is intended as the preferred measure, which is why embodiments with the displacement unit 16 are currently preferred. However, the other measures are also to be provided as alternatives or in combination with the displacement unit 16 in other embodiments, depending on the type and design of the electrode.

FIG. 2 also shows a schematic representation of the transport device 12, which comprises the gripper 10, a movement mechanism 66, e.g., portal axes or a robot arm, for moving the gripper 10, and the control system 32. In some embodiments, the transport device 12 is designed to feed electrodes to the process known from documents [1] to [3].

During operation, the following process can be carried out automatically, in particular by means of instructions from the computer program.

The method is used to pick up and grip individual sheet-like electrodes 50 in the course of the manufacture of a battery cell and comprises aspirating the electrode 50 and
a) aspirating a first region of the electrode 50 with a first suction device 28.1 and aspirating a second region of the electrode 50 with a second suction device 28.2 and relative displacement of the first and second suction devices 28.1, 28.2 with at least one directional component parallel to the sheet-like extension of the electrode 50, in order to deliberately bulge the electrode 50 for separation, and/or
b) punctually aspirating the electrode 50 in such a way that a bulging of the electrode 50 is produced already during aspiration and/or
c) blowing at an angle onto at least one, several or all of the edges 48 of the electrode 50 in order to detach a further electrode 58 adhering thereto.

By means of the double layer sensor 24 or another sensor for detecting whether one or more electrodes have been picked up by the gripper 10, it can be determined whether only a single electrode 50 has been successfully picked up.

In some embodiments, the method thus comprises the step of: detecting whether the gripped electrode 50 has been successfully separated and, depending on this, flatly aspirating the electrode 50 if it has been successfully separated and/or transporting the electrode 50 only when it has been successfully separated.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 gripper
12 transport device
14 suction device
16 displacement unit
17 displacement movement
18 bellows suction device (example of a suction unit for punctual aspiration)
20 suction field (example of a suction unit for flat aspiration)
22 nozzle unit
24 double layer sensor
26.1 first gripper segment
26.2 second gripper segment
28.1 first suction device
28.2 second suction device
30 gripper plane
32 control system
34 guide device
36 actuator
38 internal guide device
40 projection
42 recess
44 circular guide system (example of external guide device)
46 rail
48 edge
50 electrode to be gripped
52 ring nozzle
54 air duct
56 blowing air
58 adhering electrode
60 air flow
62 vacuum region
64 slot
66 movement mechanism

1. A gripper for picking up and gripping individual sheet electrodes during a manufacture of a battery cell, the gripper comprising:
a suction device for aspirating an electrode to be gripped;
a first gripper segment; and
a second gripper segment,
wherein the suction device comprises a first suction device arranged on the first gripper segment for aspirating a first region of the electrode to be gripped and a second suction device arranged on the second gripper segment for aspirating a second region of the electrode to be gripped,
wherein the gripper further comprises a displacement unit for displacing the first and second gripper segments relative to one another with at least one directional component parallel to a surface of the electrode to be gripped.

2. The gripper according to claim 1, wherein the displacement unit comprises:
a guide device for linearly guiding the first gripper segment and the second gripper segment relative to each other;
an actuator for driving a displacement movement;
an internal guide device, formed on the first gripper segment and the second gripper segment, which has a projection on one of the first gripper segment and the second gripper segment and a recess on the other of the first gripper segment and the second gripper segment, wherein the projection is configured to be received in a form-fitting manner in the recess;
an external guide device with at least one rail on which the first gripper segment and the second gripper segment are guided in a displaceable manner; and,
a guide system on which the first gripper segment is guided in a displaceable manner and on which the second gripper segment is guided in a displaceable manner,
wherein a relative displacement of the first gripper segment and the second gripper segment only takes place in one plane.

3. The gripper according to claim 1, wherein the suction device comprises several bellows suction devices for punctually aspirating the electrode, or
wherein the suction device comprise at least one suction field for flat aspiration of the electrode, or
both.

4. The gripper according to claim 3, wherein the several bellows suction devices are configured to produce a targeted bulging of the electrode by punctual aspiration, or
wherein the several bellows suction devices are configured to be controlled individually, or
wherein the several bellows suction devices are formed at least in part on the first suction device, or
wherein the several bellows suction devices are formed at least in part on the second suction device, or
wherein the several bellows suction devices are distributed over the first gripper segment and the second gripper segment, or
any combination thereof.

5. The gripper according to claim 3, wherein the first suction device has a first suction field, or
wherein the second suction device has a second suction field, or
wherein the at least one suction field is configured to generate gripping of the electrode over an entire surface after successful separation of the electrode to be gripped, or,
wherein the first suction device and the second suction device are identically designed or as mirror images of each other, or
any combination thereof.

6. The gripper according to claim 1, further comprising a nozzle unit integrated into the gripper, the nozzle unit configured to deliver an air flow or an air pulse at a predetermined oblique angle to at least one edge of the electrode to be gripped.

7. The gripper according to claim 6, wherein the nozzle unit comprises a ring nozzle configured to deliver the air flow or the air pulse at each edge on a circumference of the electrode to be gripped, or
wherein the nozzle unit comprises slots offset laterally to the suction device, or
wherein the nozzle unit comprises a first nozzle region on the first gripper segment and a second nozzle region on the second gripper segment, or
any combination thereof.

8. The gripper according to claim 1, further comprising:
a sensor for detecting whether a single or more electrodes have been picked up by the gripper.

9. A transport device for picking up and transporting individual sheet electrodes during a manufacture of a battery cell, the transport device comprising:
at least one gripper according to claim 1;
a movement mechanism for moving the gripper; and
a control system.

10. A method for picking up and gripping individual sheet electrodes during a manufacture of a battery cell, the method comprising:
aspirating a first region of an electrode with a first suction device;
aspirating a second region of the electrode with a second suction device; and
relatively displacing the first suction device and the second suction device with at least one directional component parallel to an extension of the electrode in order to bulge the electrode in a targeted manner for separation.

11. The method according to claim 10, further comprising:
punctually aspirating the electrode in such a way that a bulging of the electrode is produced already during aspiration.

12. The method according to claim 10, further comprising:
blowing at an angle onto at least one edge of the electrode in order to detach a further electrode adhering thereto.

13. The method according to claim 10, further comprising:
detecting whether a gripped electrode has been successfully separated; and,
flatly aspirating the gripped electrode when the gripped electrode has been successfully separated, or transporting the gripped electrode only if the gripped electrode has been successfully separated, or both.

14. A non-transitory computer readable medium storing a computer program comprising instructions that cause a gripper to perform the method according to claim 10.
